(19) United States
(12) Patent Application Publication
(10) Pub. No.: US 2026/0266072 A1
(43) Pub. Date: Sep. 10, 2026

(54) ENCLOSURE SYSTEM FOR BUILDING ENTRYWAY

(71) Applicant: Kawneer Company, Inc., Pittsburgh, PA (US)

(72) Inventor: Michael David MITCHELL, Woodstock, GA (US)

(73) Assignee: Kawneer Company, Inc., Pittsburgh, PA (US)

(21) Appl. No.: 19/440,368

(22) Filed: Jan. 5, 2026

Related U.S. Application Data
(60) Provisional application No. 63/767,393, filed on Mar. 5, 2025.

(51) Int. Cl. E04G 21/24; E04G 21/28; E06B 1/52

(52) U.S. Cl. CPC E04G 21/241; E04G 21/28; E06B 1/52

(57) ABSTRACT

An enclosure system for a building includes an entryway including opposing left and right frame-side jambs and a frame-side transom, and a temporary enclosure system installable within the entryway and including a left temporary door-side jamb attachable to the left frame-side jamb, a right temporary door-side jamb attachable to the right frame-side jamb, a temporary transom attachable to the frame-side transom, and temporary doors installed in the entryway. A permanent enclosure system is installed in the entryway after removing the temporary enclosure system and includes a left permanent door-side jamb attachable to the left frame-side jamb, a permanent right door-side jamb attachable to the right frame-side jamb, a permanent transom attachable to the frame-side transom, and permanent doors hung within the entryway.

### FIELD OF THE DISCLOSURE

The present disclosure relates generally to the construction and installation of door frames and, more particularly, to an enclosure system for a building that includes a temporary enclosure system used to temporarily secure the building until permanent doors and associated sub-framing can be installed.

### BACKGROUND OF THE DISCLOSURE

When constructing portions of a building with a large entryway, such as a storefront door entry, the timely installation of a door and the corresponding frame assembly may be required to properly enclose (“dry-in”) the building. Without proper building enclosure, the interior of the building is exposed to the elements, which may affect the condition of interior building materials and structures. Moreover, proper building enclosure helps prevent possible theft and vandalism within the interior of the building.

However, when supply-chain or labor issues prevent the timely production of doors and/or frames, the entryway opening for the door may be left exposed for the duration of the lead time required to manufacture and deliver the door and associated framework. While the framing process for the storefront may be performed prior to the delivery of the door and frame, the complete assembly, installation, and glazing of the storefront may not be possible until the frame and the door are fully assembled.

These delays in both the delivery of the door/frame and the construction of the storefront may hinder the timely construction of the project. Further, for door/frame manufacturing companies, it may become difficult to obtain jobs with long lead times, such that customers will choose the shortest lead time to provide the quickest building enclosure.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments disclosed herein include an enclosure system for a building that includes an entryway for the building defined by opposing left and right frame-side jambs and a frame-side transom extending between the left and right frame-side jambs, a temporary enclosure system installable within the entryway and including a left temporary door-side jamb attachable to the left frame-side jamb to form a temporary assembled left jamb, a right temporary door-side jamb attachable to the right frame-side jamb to form a temporary assembled right jamb, a temporary transom attachable to the frame-side transom to form a temporary assembled transom, and one or more temporary doors extending between the temporary assembled left and right jambs and vertically to the temporary assembled transom. After removing the temporary enclosure system from the entryway, a permanent enclosure system may be installed within the entryway, the permanent enclosure system including a left permanent door-side jamb attachable to the left frame-side jamb to form a permanent assembled left jamb, a permanent right door-side jamb attachable to the right frame-side jamb to form a permanent assembled right jamb, a permanent transom attachable to the frame-side transom to form a permanent assembled transom, and one or more permanent doors hung within the entryway and extending between the permanent assembled left and right jambs and vertically to the permanent assembled transom. In a further embodiment, the left and right frame-side jambs each include a first mating feature, and the left and right temporary door-side jambs each include a second mating feature matable with the first mating feature to operatively couple the left and right temporary door-side jambs to the left and right frame-side jambs, respectively. In another further embodiment, the first mating feature comprises a channel, and the second mating feature comprises a flange sized to be received within the channel. In another further embodiment, the frame-side transom includes a first base and opposing first and second legs extending from the first base, and the temporary transom includes a second base and opposing third and fourth legs extending from the second base, and wherein the third and fourth legs are received within an interior region defined between the opposing first and second legs. In another further embodiment, the first and second legs each provide a first mating feature, and the third and fourth legs each provide a second mating feature matable with the first mating feature as the third and fourth legs are received within the interior region. In another further embodiment, the temporary enclosure system includes one or more cover plates attachable to opposing sides of the temporary assembled transom. In another further embodiment, the left and right frame-side jambs each include a first mating feature, and the left and right permanent door-side jambs each include a second mating feature matable with the first mating feature to operatively couple the left and right permanent door-side jambs to the left and right frame-side jambs, respectively. In another further embodiment, the first mating feature comprises a channel, and the second mating feature comprises a flange sized to be received within the channel. In another further embodiment, one or more notches are defined on the first mating feature and a corresponding one or more protrusions are defined on the second mating feature and sized to be received by the one or more notches. In another further embodiment, the frame-side transom includes a first base and opposing first and second legs extending from the first base, and the permanent transom includes a second base and opposing third and fourth legs extending from the second base, and wherein the third and fourth legs are received within an interior region defined between the opposing first and second legs. In another further embodiment, first and second legs each provide a first mating feature, and the third and fourth legs each provide a second mating feature matable with the first mating feature as the third and fourth legs are received within the interior region. In another further embodiment, the permanent enclosure system further includes an internal closer arranged within the permanent assembled transom. In another further embodiment, the permanent enclosure system includes one or more cover plates attachable to opposing sides of the permanent assembled transom.

Embodiments disclosed herein include a method of constructing an enclosure system for a building including constructing an entryway for the building, the entryway being defined by opposing left and right frame-side jambs and a frame-side transom extending between the left and right frame-side jambs, installing a temporary enclosure system within the entryway and thereby securing the building, wherein installing the temporary enclosure system includes attaching a left temporary door-side jamb to the left frame-side jamb and thereby forming a temporary assembled left jamb, attaching a right temporary door-side jamb to the right frame-side jamb and thereby forming a temporary assembled right jamb, attaching a temporary transom to the frame-side transom and thereby forming a temporary assembled transom, and hanging one or more temporary doors within the entryway, the one or more temporary doors extending between the temporary assembled left and right jambs and vertically to the temporary assembled transom. The method further includes removing the temporary enclosure system from the entryway, installing a permanent enclosure system within the entryway and thereby securing the building, wherein installing the permanent enclosure system includes attaching a left permanent door-side jamb to the left frame-side jamb and thereby forming a permanent assembled left jamb, attaching a right permanent door-side jamb to the right frame-side jamb and thereby forming a permanent assembled right jamb, attaching a permanent transom to the frame-side transom and thereby forming a permanent assembled transom, and hanging one or more permanent doors within the entryway, the one or more permanent doors extending between the permanent assembled left and right jambs and vertically to the permanent assembled transom. In a further embodiment, the left and right frame-side jambs each include a first mating feature, and the left and right temporary door-side jambs each include a second mating feature, and wherein the attaching the left and right temporary door-side jambs to the left and right frame-side jambs, respectively, comprises mating the first and second mating features and thereby operatively coupling the left and right temporary door-side jambs to the left and right frame-side jambs, respectively. In another further embodiment, the frame-side transom includes a first base and opposing first and second legs extending from the first base, and the temporary transom includes a second base and opposing third and fourth legs extending from the second base, and wherein attaching the temporary transom to the frame-side transom comprises receiving the third and fourth legs within an interior region defined between the opposing first and second legs. In another further embodiment, installing the temporary enclosure system includes attaching one or more cover plates to opposing sides of the temporary assembled transom. In another further embodiment, left and right frame-side jambs each include a first mating feature, and the left and right permanent door-side jambs each include a second mating feature, and wherein attaching the left and right permanent door-side jambs to the left and right frame-side jambs, respectively, comprises mating the first and second mating features and thereby operatively coupling the left and right permanent door-side jambs to the left and right frame-side jambs, respectively. In another further embodiment, the frame-side transom includes a first base and opposing first and second legs extending from the first base, and the permanent transom includes a second base and opposing third and fourth legs extending from the second base, and wherein attaching the permanent transom to the frame-side transom comprises receiving the third and fourth legs within an interior region defined between the opposing first and second legs. In another further embodiment, the method includes installing an internal closer within the permanent assembled transom. In another further embodiment, installing the permanent enclosure system includes attaching one or more cover plates to opposing sides of the permanent assembled transom.

### BRIEF DESCRIPTION OF THE DRAWINGS

FIG. 1 is a schematic front view of an example enclosure system that may incorporate the principles of the present disclosure.

FIG. 2 is a schematic front view of the enclosure system of FIG. 1 with an example temporary enclosure system installed in accordance with the principles of the present disclosure.

FIGS. 3A and 3B are cross-sectional views of the temporary enclosure system taken along the lines indicated in FIG. 2.

FIG. 4 is a schematic view of the system of FIG. 1 with a permanent enclosure system installed in accordance with the principles of the present disclosure.

FIGS. 5A-5C are cross-sectional views of the permanent enclosure system taken along the lines indicated in FIG. 4.

### DETAILED DESCRIPTION

The present disclosure relates generally to the construction and installation of door frames and, more particularly, to an enclosure system for a building that includes a temporary enclosure system used to temporarily secure the building until doors can be properly hung to fully secure the building.

The present disclosure describes a temporary door and subframe assembly that can be installed in a door opening or “entryway” prior to receiving and installing permanent doors and its associated permanent subframe. This allows a builder to purchase stock framing lengths and perform fabrication of a storefront system, install said system into the building, and ultimately glaze and seal the building including the entryway with temporary components. As a result, the building can be accessed, enclosed, and secured for building occupancy. Then once the permanent doors and subframe arrive on the job site, the temporary doors and subframe can be removed and stored for future use; e.g., the temporary doors and subframe assembly can be re-used in a subsequent build project. This transition from temporary subframe and doors to permanently installed and doors and subframe is virtually seamless, while simultaneously protecting the building from uncontrolled access. This also protects the permanent doors and associated subframe from construction damage while helping to achieve building occupancy sooner.

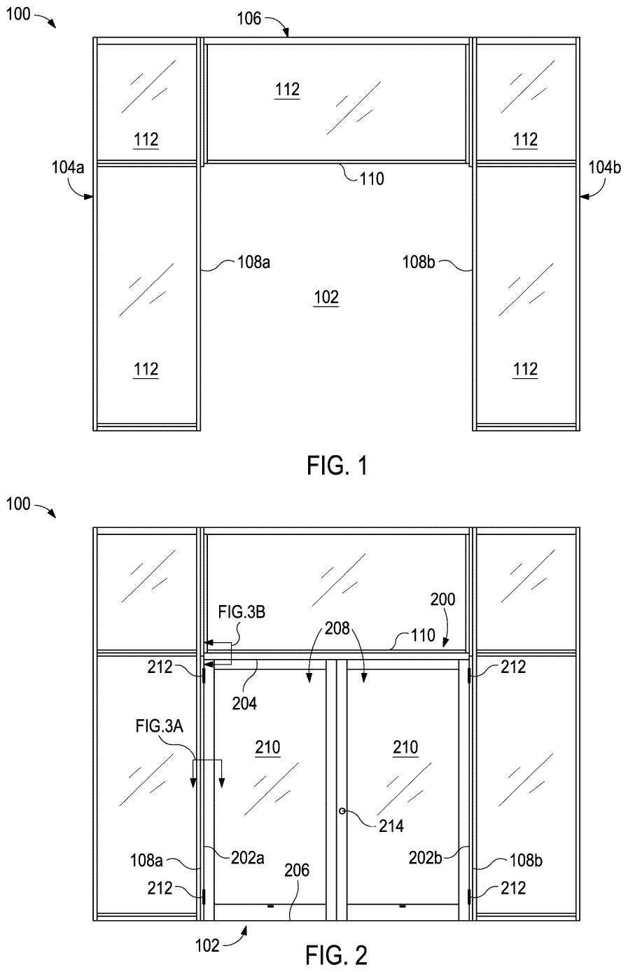

FIG. 1 is a schematic front view of an example enclosure system 100 that may incorporate the principles of the present disclosure. The enclosure system 100 (hereafter, “the system 100”) may form part of a commercial or business building, such as a storefront or business establishment. As illustrated, the system 100 may include a frame assembly that defines an opening or “entryway” 102 configured to receive one or more doors that facilitate ingress or egress access for the building. More specifically, the frame assembly may include a first or “left” sidelight section 104a, a second or “right” sidelight section 104b, and a header section 106 extending between the left and right sidelight sections 104a, b. The combination of the left and right sidelight sections 104a, b and the header section 106 cooperatively define the entryway 102. In some applications, the entryway 102 may be defined by a combination of only one of the sidelight sections 104a, b and the header section 106. In such embodiments, the opposite side of the sidelight section 104a, b may comprise an upright support or “substrate jamb,” such as at an exterior wall condition of a building.

The entryway 102 may be temporarily defined or provided by opposing partial (split) jambs and a partial (split) header or “transom” extending between the slip jambs. The split jambs and transom allow a contractor to finish assembling and “drying in” (e.g., glazing) the system 100 before permanent doors and corresponding permanent sub-framing are received on-site to be installed in the entryway 102, which could be several weeks later. Consequently, this allows a contractor to enclose the entryway 102 with a temporary enclosure, including a temporary subframe and temporary door(s), thereby mitigating potential damage from the elements or possible theft or vandalism within the interior of the building. Once the permanent doors are received, the temporary subframe and doors are removed, corresponding door-side jambs and a door-side transom are attached to the partial jambs and the partial transom, respectively, and the permanent doors can then be hung properly within the entryway 102 as designed.

As illustrated, the left sidelight section 104a may provide a first or “left” frame-side jamb 108a, the right sidelight section 104b may provide a second or “right” frame-side jamb 108b, and the header section 106 may provide a frame-side transom 110. The left and right frame-side jambs 108a, b extend substantially vertically, and the frame-side transom 110 extends substantially horizontal and between the left and right frame-side jamb 108a, b. The frame-side jambs 108a, b and the frame-side transom 110 cooperatively define the entryway 102. Each frame-side jamb 108a, b structurally comprises a portion (e.g., one half) of a full structural jamb, and the frame-side transom 110 structurally comprises a portion (e.g., one half) of a full structural header. As described below, the frame-side jambs 108a, b are designed to mate with both temporary and permanent door-side jambs, and the frame-side transom 110 is designed to mate with both temporary and permanent door-side transoms.

The frame-side jambs 108a, b and the frame-side transom 110 may be installed during assembly of the system 100 to allow the remaining portions of the system 100 to be completed (e.g., “dried in” or glazed). In particular, by installing the frame-side jambs 108a, b and the frame-side transom 110, corresponding panels 112 may be installed in the left and right side light sections 104a, b and the header section 106. Each panel 112 may include, but is not limited to, a pane of window glass, polycarbonate, or another clear, translucent, tinted, or opaque panel. In the illustrated embodiment, each sidelight section 104a, b includes two sidelight bays with corresponding panels 112 flanking the entryway 102. In other embodiments, more or less than two sidelight bays may be included in one or both sidelight section 104a, b. Similarly, the header section 106 is shown including only one transom bay with a corresponding panel 112, but could alternatively include two or more smaller transom bays, without departing from the scope of this disclosure. In embodiments that include only one of the sidelight sections 104a, b, one of the frame-side jambs 108a, b may be attached (anchored) to an upright support or “substrate jamb”. In such embodiments, no panels 112 would be installed on that side of the entryway 102.

According to embodiments of the present disclosure, after constructing the system 100 as shown in FIG. 1, the entryway 102 may be temporarily enclosed with a temporary enclosure system. The temporary enclosure system may be configured to be removably attached to the frame-side jambs 108a, b and the frame-side transom 110, and helps secure the building and thereby prevents damage from weather events and/or theft and vandalism from occurring within the building. The temporary enclosure system will remain in place until the permanent entryway 102 components are received on-site, at which point the temporary enclosure system will be removed and replaced with a permanent subframe and doors hung to permanently secure the building.

FIG. 2 is a schematic side view of the system 100 with an example temporary enclosure system 200 installed in accordance with the principles of the present disclosure. As illustrated, the temporary enclosure system 200 includes a first or “left” temporary door-side jamb 202a, a second or “right” temporary door-side jamb 202b, and a temporary transom 204, alternately referred to as a “transom bar”. The left temporary door-side jamb 202a is removably coupled to the left frame-side jamb 108a, the right temporary door-side jamb 202b is removably coupled to the right frame-side jamb 108b, and the temporary transom 204 is removably coupled to the frame-side transom 110. The temporary transom 204 extends between the left and right temporary door-side jambs 202a, b.

Each temporary door-side jamb 202a, b structurally comprises a portion (e.g., one half) of a full structural jamb, and the temporary transom 204 structurally comprises a portion (e.g., one half) of a full structural header. Accordingly, mating the temporary door-side jambs 202a, b with the frame-side jambs 108a, b, respectively, creates full (complete) structural jambs (i.e., temporary assembled left and right jambs), and mating the temporary transom 204 with the frame-side transom 110 creates a full (complete) structural header (e.g., a temporary assembled transom). The temporary door-side jambs 202a, b and the temporary transom 204 may each comprise extrusions made of a rigid material, such as aluminum, or other suitable construction materials.

In some applications, a threshold 206 may be installed at the bottom of the entryway 102. The threshold 206 may be permanently secured to an underlying substrate, such as the ground, a concrete slab, or another common type of underlayment. The threshold 206 may be temporarily installed after installing the temporary door-side jambs 202a, b.

In some embodiments, the system 100 and portions of the temporary enclosure system 200 may be assembled on the ground (e.g., prostrate). In such embodiments, the temporary door-side jambs 202a, b are coupled to the frame-side jambs 108a, b, respectively, and the temporary transom 204 is coupled to the frame-side transom 110, thereby defining the entryway 102. The threshold 206 may then be secured to the bottom of the temporary door-side jambs 202a, b using one or more mechanical fasteners. With the threshold 206 secured, the system 100 may then be lifted and pivoted to vertical. In at least one embodiment, once the system 100 is pivoted to vertical and arranged properly relative to the remaining building structure, the threshold 206 may be attached to the underlying substrate.

Once the temporary door-side jambs 202a, b are operatively coupled to the frame-side jambs 108a, b, respectively, and the temporary transom 204 is operatively coupled to the frame-side transom 110, one or more temporary doors 208 are installed and otherwise attached to the temporary door-side jambs 202a, b to fully enclose the entryway 102. Two temporary doors 208 are depicted in FIG. 2, and each temporary door 208 extends vertically between the threshold 206 and the temporary transom 204. In some embodiments, as illustrated, one or both of the doors 208 may include a corresponding panel 210. Each panel 210 may include, but is not limited to, a pane of window glass, polycarbonate, or another clear, translucent, tinted, or opaque panel. In other embodiments, however, the panels 210 may be omitted and one or both of the temporary doors 208 may comprise a solid or hollow enclosure made entirely of a metal (e.g., aluminum, stainless steel, etc.), wood (e.g., solid wood, plywood, oriented strand board or “OSB”, etc.), a plastic, a composite material, or any combination thereof.

Each temporary door 208 extends horizontally between the horizontal center of the entryway 102 and the left and right temporary door-side jambs 202a, b. More specifically, the left temporary door 208 extends between the horizontal center of the entryway 102 and the left temporary door-side jamb 202a, and the right temporary door 208 extends between the horizontal center of the entryway 102 and the right temporary door-side jamb 202b. The temporary doors 208 may be pivotably secured to the temporary door-side jambs 202a, b, respectively, using one or more hinges 212. Upon replacing the temporary enclosure system 200 with a permanent enclosure system, as discussed below, the hinges 212 may either be removed and kept with the temporary enclosure system 200 or used in the permanent enclosure system. In some applications, two hinges 212 are disposed vertically along each temporary door-side jamb 202a, b. However, more or less than two hinges 212 may be used to pivotably mount the temporary doors 208 to the temporary enclosure system 200.

In at least one embodiment, the temporary doors 208 may include a locking mechanism 214 to lock and control access through the entryway 102. This will allow contractors to obtain occupancy permits while awaiting delivery of the permanent doors.

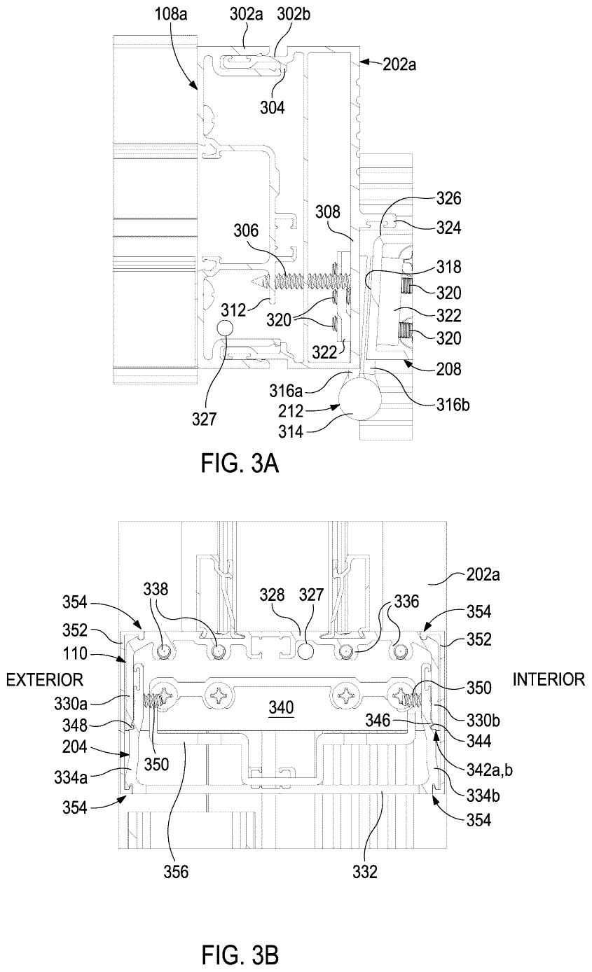

FIGS. 3A and 3B are enlarged, cross-sectional views of select portions of the temporary enclosure system 200, as taken along the lines indicated in FIG. 2, according to one or more embodiments. Referring first to FIG. 3A, the left temporary door-side jamb 202a is depicted as being removably attached (secured) to the left frame-side jamb 108a. While the following discussion is related to the left temporary door-side jamb 202a and the left frame-side jamb 108a, the discussion is equally applicable to the right temporary door-side jamb 202b being removably attached to the right frame-side jamb 108b.

As illustrated, the frame-side jamb 108a and the temporary door-side jamb 202a may each provide complementary mating features 302a and 302b, respectively, that help removably attach the temporary door-side jamb 202a to the frame-side jamb 108a. In the illustrated embodiment, the first mating feature 302a comprises a slot or channel defined by the frame-side jamb 108a, and the second mating feature 302b comprises a projection or flange extending from the temporary door-side jamb 202a and sized to be received within the channel. In other embodiments, however, the channel may alternatively be defined by the temporary door-side jamb 202a, and the flange may be provided by the frame-side jamb 108a, without departing from the scope of the disclosure. As illustrated, the frame-side and temporary jambs 108a, 202a each provide two sets of complementary mating features 302a, b.

The mating features 302a and 302b are removable coupled or otherwise “mated” by advancing the second mating feature 302b (i.e., the flange) into the first mating feature 302a (i.e., the channel). In some embodiments, the temporary door-side jamb 202a may further include a stop shoulder 304 extending from the second mating feature 302b. The stop shoulder 304 may be configured to engage a portion of the first mating feature 302a before the second mating feature 302b bottoms out within the first mating feature 302a, thereby ensuring desirable (predetermined) spacing between the frame-side and door-side jambs 108a, 202a.

In addition to the mating features 302a and 302b, and as further illustrated in FIG. 3A, one or more fasteners 306 may be used to help removably secure the temporary door-side jamb 202a to the frame-side jamb 108. In particular, the fastener(s) 306 may extend through an inner wall 308 of the temporary door-side jamb 202a and penetrate the frame-side jamb 108a at corresponding anchor points 312 forming part of the left frame-side jamb 108a. The fastener(s) 306 may be screws, as illustrated, but could alternatively comprise other suitable mechanical fasteners.

Still referring to FIG. 3A, and as briefly mentioned above, the hinge(s) 212 (one shown) are included to pivotably mount the temporary doors 208 to the door-side jamb 202a. As illustrated, the hinge 212 includes a center or “knuckle” 314 and two halves or “leaves” 316a and 316b pivotably coupled to each other at the knuckle 314 and extending therefrom. The first leaf 316a is configured to be secured to the door-side jamb 202a at the inner wall 308, and the second leaf 316b is configured to be secured to the temporary door 208 at an outer wall 318 of the temporary door 208. One or more hinge fasteners 320 (e.g., screws) may be used to secure the first leaf 316a to the door-side jamb 202a, and one or more additional hinge fasteners 320 (e.g., screws) may be used to secure the second leaf 316b to the temporary door 208. In at least one embodiment, one or both of the door-side jamb 202a and the temporary door 208a may further include a hinge plate 322 arranged to receive the corresponding hinge fasteners 320 and help increase the robustness (rigidity) of the mechanical attachment.

In some embodiments, the temporary door-side jamb 202a may include a jamb gasket projection 324 provided along (e.g., extending laterally from) the inner wall 308 and extending laterally therefrom. The jamb gasket projection 324 may be configured to receive a seal or gasket (not shown) operable to provide a seal between the door-side jamb 202a and the back side of the temporary door 208 when the temporary door 208 is closed. In some embodiments, the jamb gasket projection 324 may comprise an extruded door stop with reglet for gasketing. In other embodiments, however, the jamb gasket projection 324 may comprise a screw applied door stop. In at least one embodiment, the temporary door 208 defines a curved or arcuate corner 326 that is rounded in order to pivot across the jamb gasket projection 324 without interfering with the corresponding gasket, seal, or jamb on the opposite side of the door and jamb clearance.

In some embodiments, devices requiring electricity may be installed within the enclosure system 100 and otherwise form part thereof. For example, signage, power-generating devices (e.g., solar panels, power generating windmills, etc.), electrochromic glass (or “smart glass”), sensors, lighting devices, automation actuators, surveillance and communication devices (e.g., antennas), access and control devices (e.g., magnetic locks, motor or solenoid driven exit devices, biometric readers, etc.), electrified hinges, and/or EPT hardware, may each be attached to the enclosure system 100. To be able to convey power to or from such devices, or to otherwise facilitate electrical (data) communication with these electrical devices, attendant wires (wiring) may be run through (within) portions of the left frame-side jamb 108a (and/or the right frame side jamb 108b.

As shown, one or more wires 327 may be installed within a cavity defined in the frame-side jamb 108a prior to installing the temporary left door-side jamb 202a, thus alleviating challenges associated with routing (pushing/pulling) wires through elongated hidden channels that often have constrictions and hidden obstacles. Installing the temporary left door-side jamb 202a will hide the wires 327, thereby containing the wires 327 within the temporary assembled left jambs.

Referring now to FIG. 3B, the temporary transom 204 is depicted as being removably attached to the frame-side transom 110, which is permanent. As illustrated, the frame-side transom 110 and the temporary transom 204 may each exhibit a generally C-or U-shaped geometry. In particular, the frame-side transom 110 provides a base 328 and opposing first and second legs 330a and 330b extending from the base 328, and the temporary transom 204 similarly provides a base 332 and opposing first and second legs 334a and 334b extending from the base 332.

The frame-side transom 110 includes one or more screw splines 336 provided on the base 328 for receiving a corresponding one or more screws 338 to secure the frame-side transom 110 to the system 100 (FIG. 1) and, more specifically, to the temporary door-side jamb 202a. The frame-side transom110 is permanently attached to the framing system outside of the removable components. Once the frame-side transom 110 is properly mounted, the temporary transom 204 can then be mounted to the frame-side transom 110. In some embodiments, as illustrated, this can be accomplished by extending the legs 334a, b of the temporary transom 204 into an interior 340 of the frame-side transom 110 and such that the legs 330a, b of the frame-side transom 110 extend over the legs 334a, b. In other embodiments, however, the legs 330a, b of the frame-side transom 110 may be configured to be received within the legs 334a, b of the temporary transom 204 and, therefore, received within an interior of the temporary transom 204, without departing from the scope of the disclosure.

In some embodiments, the frame-side and temporary transoms 110, 204 may provide complementary mating features 342a and 342b, alternately referred to as “anti-reverse” features. In particular, the first mating feature 342a comprises a notch 344 provided on each leg 330a, b of the frame-side transom 110, and the second mating feature 342 b comprises a protrusion 346 provided on each leg 334a, b of the temporary transom 204. Upon receiving the legs 334a, b of the temporary transom 204 within the interior 340 of the frame-side transom 110 and advancing the temporary transom 204 into the interior 340, the protrusion 346 will eventually locate and be received within the notch 344, thereby helping to secure the temporary transom 204 to the frame-side transom 110. As will be appreciated, the notch 344 may alternatively be defined on the second mating feature 342b and the protrusion 346 may alternatively be defined on the first mating feature 342a, without departing from the scope of the disclosure. In some embodiments, further retention elements may be included, such as multiple protrusions similar to the protrusions 346, which may reinforce the connection point and help prevent further vertical movement.

Those skilled in the art will readily appreciate that the mating features 342a, b, including the notches 344 and corresponding protrusions 346, are not limited to what is depicted in FIG. 3B. Rather, additional methods, systems, and mechanisms for mating and securing the temporary transom 204 to the frame-side transom 110 may be employed, without departing from the scope of this disclosure.

As illustrated, the temporary transom 204 may further include a stop shoulder 348 extending from the second mating feature 342b (or otherwise from the legs 334a, b). The stop shoulder 348 may be configured to engage a portion of the first mating feature 342a (or otherwise the legs 330a, b) before the legs 334a, b bottom out within the interior 340 of the frame-side transom 110. The stop shoulder 348 ensures desirable (predetermined) spacing between the frame-side and temporary transoms 110, 204.

In some embodiments, the temporary transom 204 may be further secured to the frame-side transom 110 using one or more mechanical fasteners 350 (two shown). The mechanical fasteners 350 extend laterally through overlapping sections of the legs 330a, b and 334a, b, thereby further securing the temporary transom 204 to the frame-side transom 110.

In one or more embodiments, once the frame-side transom 110 and the temporary transom 204 are secured together, as generally described above, one or more cover plates 352 may be attached to the assembled frame-side and temporary transoms 110, 204. As shown, one cover plate 352 may be positioned on the exterior of the system 100 (FIG. 1), and another cover plate 352 may be positioned on the interior of the system 100. Each cover plate 352 may provide or otherwise define one or more matable features 354 used to removably attach the cover plate 352. The matable features 354 may include, for example, corresponding hook and slot features defined in one or both of the frame-side and temporary transoms 110, 204. The cover plates 352 may help enhance the aesthetic appeal of the assembled frame-side and temporary transoms 110, 204.

In some embodiments, the system 100 (FIG. 1) may include a concealed overhead or “internal” closer (not shown) mounted within the header of the door frame and hidden by a cover plate. In such embodiments, the internal closer may be arranged generally within the interior 340 of the frame-side transom 110. Moreover, in such embodiments, a hanger bracket 356 may be installed within the interior 340 to accommodate portions and parts of the internal closer and otherwise hold the internal closer in a static position within the interior 340 of the frame-side transom 110. In other embodiments, however, the internal closer may be omitted from the system 100, without departing from the scope of the disclosure.

As described above, various electrical devices may be attached to or otherwise form part of the enclosure system 100. To be able to convey power to or from such devices, or to otherwise facilitate electrical (data) communication with these electrical devices, attendant wires (wiring) may be ran through (within) portions of the frame-side transom 110. As shown, one or more wires 327 may be installed within a cavity defined in the frame-side transom 110 prior to installing the temporary transom 204. Installing the temporary transom 204 may hide the wires 327, thereby containing the wires 327 within the temporary assembled transom. In some embodiments, the wire 327 shown in FIG. 3B may be connected to and form an extension of the wire 327 of FIG. 3A.

Referring again to FIG. 2, when the permanent doors and associated sub-framing for the system 100 are delivered and ready to be installed into the entryway 102, the temporary enclosure system 200 may be disassembled and otherwise removed from the entryway 102 in preparation for receipt and hanging of the permanent doors. In particular, the temporary doors 208 may first be detached from the entryway 102 by detaching the temporary doors 208 from the hinges 210. The temporary transom 204 may then be detached from the frame-side transom 110 by reversing the steps used to install the temporary transom 204 (e.g., removing the cover plates 352, unscrewing the fasteners 350, and decoupling the mating features 342a, b). The left and right temporary door-side jambs 202a, b may then be detached from the corresponding left and right frame-side jambs 108a, b by reversing the process used to install the jambs 202a, b (e.g., unscrewing the fasteners 306, and decoupling the complementary mating features 302a, b). The threshold 206 may then be removed as a temporary component and subsequently replaced with a permanent threshold. Once the temporary enclosure system 200 is fully disassembled, the system 100 will be in the state depicted in FIG. 1 once again. The temporary doors 208, the temporary door-side jambs 202a, b, and the temporary transom 204 may each be re-used on a subsequent project.

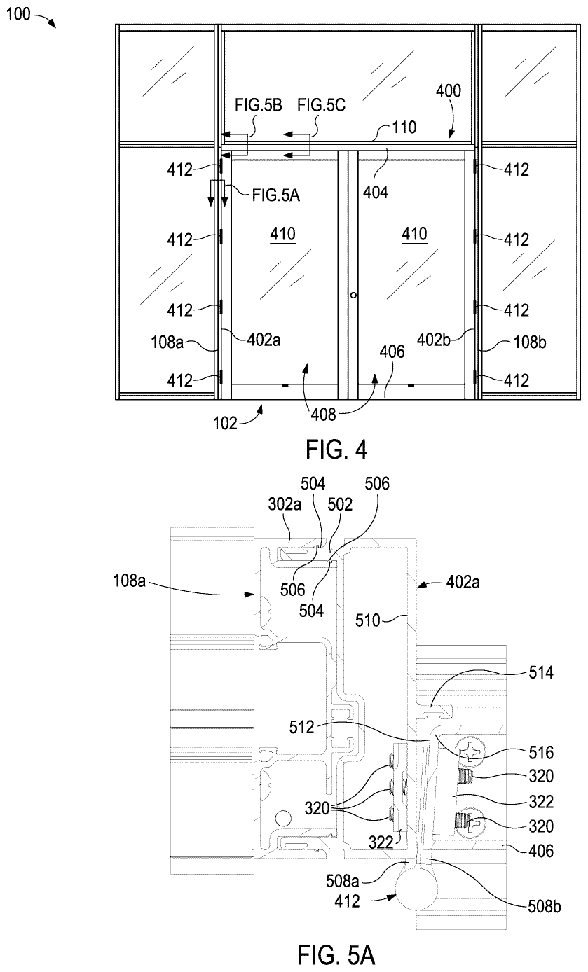

FIG. 4 is a schematic side view of the system 100 with an example permanent enclosure system 400 installed in accordance with the principles of the present disclosure. As illustrated, the permanent enclosure system 400 includes a first or “left” permanent door-side jamb 402a, a second or “right” permanent door-side jamb 402b, and a permanent transom 404, alternately referred to as a “transom bar”. The left permanent door-side jamb 402a is removably coupled to the left frame-side jamb 108a, the right permanent door-side jamb 402b is removably coupled to the right frame-side jamb 108b, and the permanent transom 404 is removably coupled to the frame-side transom 110. The permanent transom 404 extends horizontally between the left and right permanent door-side jambs 402a, b.

Each permanent door-side jamb 402a, b structurally comprises a portion (e.g., one half) of a full structural jamb, and the permanent transom 404 structurally comprises a portion (e.g., one half) of a full structural header. Accordingly, mating the permanent door-side jambs 402a, b with the frame-side jambs 108a, b, respectively, creates full (complete) structural jambs (e.g., permanent assembled left and right jambs), and mating the permanent transom 404 with the frame-side transom 110 creates a full (complete) structural header (e.g., a permanent assembled transom). The permanent door-side jambs 402a, b and the permanent transom 404 may each comprise extrusions made of a rigid material, such as aluminum, or other suitable construction materials.

In some embodiments, once the permanent door-side jambs 402a, b are operatively coupled to the frame-side jambs 108a, b, respectively, and the permanent transom 404 is operatively coupled to the frame-side transom 110, a permanent threshold 406 may then be installed and otherwise secured to one or both of the underlying substrate and the permanent door-side jambs 402a, b using one or more mechanical fasteners. The permanent threshold 406 may be the same as or similar to the threshold 206 (FIG. 2), but could alternatively be specially designed for the permanent installation. In some embodiments, the permanent threshold 406 is compatible with various hardware components provided with the permanent doors.

One or more permanent doors 408 may then be installed and otherwise attached to the permanent door-side jambs 402a, b to fully enclose the entryway 102. Two permanent doors 408 are depicted in FIG. 4, and each permanent door 408 extends vertically between the permanent threshold 406 and the permanent transom 404. In some embodiments, as illustrated, one or both of the doors 408 may include a corresponding panel 410. Each panel 410 may include, but is not limited to, a pane of window glass, polycarbonate, or another clear, translucent, tinted, or opaque panel. In some embodiments, the permanent doors 408 include high performance glass for thermal applications, acoustic applications, impact rated applications, etc. where the temporary could be ¼″ tempered glass to enclose the opening.

Each permanent door 408 extends horizontally between the horizontal center of the entryway 102 and the left and right permanent door-side jambs 402a, b. More specifically, the left permanent door 408 extends between the horizontal center of the entryway 102 and the left permanent door-side jamb 402a, and the right permanent door 408 extends between the horizontal center of the entryway 102 and the right permanent door-side jamb 402b. The permanent doors 408 may be pivotably secured to the door-side jambs 402a, b, respectively, using one or more hinges 412. The hinges 412 may be the same as or similar to the hinges 212 (FIG. 2). In some applications, four hinges 412 are disposed vertically along each permanent door-side jamb 402a, b to accommodate the increased performance and weight of the permanent assembly 400. However, more or less than four hinges 412 may be used to pivotably mount the permanent doors 408 to the permanent enclosure system 400.

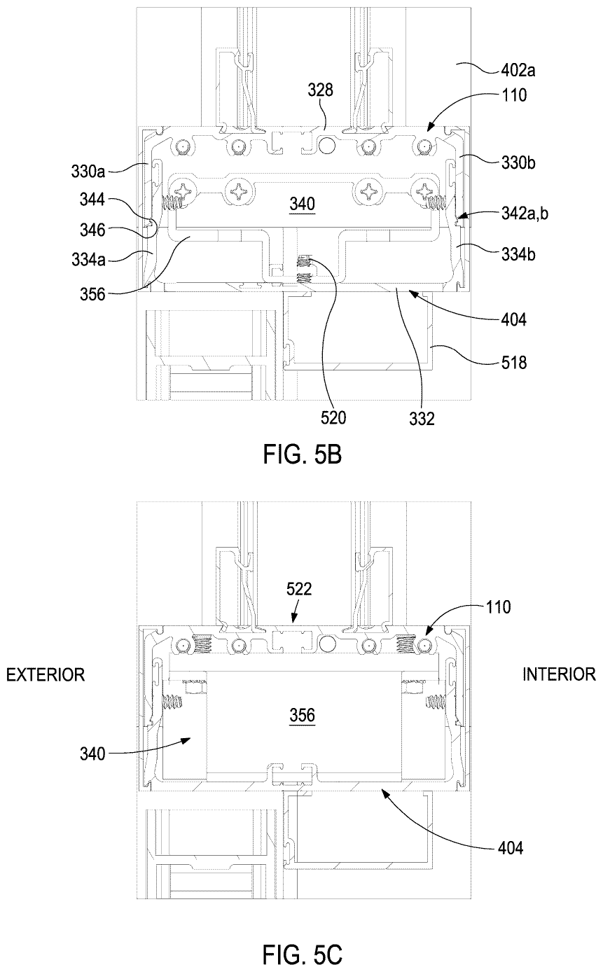

FIGS. 5A-5C are enlarged, cross-sectional views of select portions of the permanent enclosure system 400, as taken along the lines indicated in FIG. 4, according to one or more embodiments. Referring first to FIG. 5A, the left permanent door-side jamb 402a is depicted as being attached (secured) to the left frame-side jamb 108a. The left permanent door-side jamb 402a is substantially similar to the left temporary door-side jamb 202a (FIG. 3A) and may be best understood with reference thereto. While the following discussion is related to the left permanent door-side jamb 402a and the left frame-side jamb 108a, the discussion is equally applicable to the right permanent door-side jamb 402b being removably attached to the right frame-side jamb 108b.

As illustrated, the frame-side jamb 108a includes the first mating feature 302a, and the permanent door-side jamb 402a may provide a complementary second mating feature 502, and the mating features 302a, 502 help removably attach the permanent door-side jamb 402a to the frame-side jamb 108a. In the illustrated embodiment, the first mating feature 302a comprises a slot or channel defined by the frame-side jamb 108a, and the second mating feature 502 comprises a projection or flange extending from the permanent door-side jamb 402a and sized to be received within the channel. The mating features 302a, 502 are coupled or otherwise “mated” by advancing the second mating feature 502 (i.e., the flange) into the first mating feature 302a (i.e., the channel). As illustrated, the frame-side and permanent jambs 108a, 402a each provide two sets of complementary mating features 302a, 502.

In some embodiments, the mating features 302a, 502 may be enhanced with one or more “anti-reverse” features, namely, one or more notches 504 (two shown) defined on the first mating feature 302a and a corresponding one or more protrusions 506 (two shown) defined on the second mating feature 502. As the second mating feature 302b is extended into the first mating feature 302a, the protrusions 506 will eventually locate and be received within the corresponding notches 504, thereby helping to secure the permanent door-side jamb 402a to the frame-side jamb 108a. The attachment between the notches 504 and protrusions 506 helps to laterally constrain the permanent door-side jambs 402a, b relative to the frame-side jambs 108a, b. As will be appreciated, the notches 504 may alternatively be defined on the second mating feature 502 and the protrusions 506 may alternatively be defined on the first mating feature 302a, without departing from the scope of the disclosure.

Those skilled in the art will readily appreciate that the mating features 302a, 502 are not limited to what is depicted in FIG. 5A. Rather, additional methods, systems, and mechanisms for mating and securing the permanent door-side jamb 402a to the frame-side jamb 108a may be employed, without departing from the scope of this disclosure.

Still referring to FIG. 5A, and as briefly mentioned above, the hinge(s) 412 (one shown) are included to pivotably mount the permanent doors 408 to the permanent door-side jamb 402a. A first leaf 508a of the hinge 412 is configured to be secured to the permanent door-side jamb 402a at an inner wall 510, and the second leaf 508b is configured to be secured to the permanent door 406 at an outer wall 512 of the permanent door 406. One or more hinge fasteners 320 (e.g., screws) may be used to secure the first leaf 508a to the permanent door-side jamb 402a, and to further secure the second leaf 508b to the permanent door 406. In at least one embodiment, one or both of the door-side jamb 402a and the permanent door 406 may further include the hinge plates 322 described above.

In some embodiments, the permanent door-side jamb 402a may include a jamb gasket projection 514 provided along (e.g., extending laterally from) the inner wall 308. The jamb gasket projection 514 may be configured to receive a seal or gasket (not shown) operable to provide a seal between the permanent door-side jamb 402a and the permanent door 406 when the permanent door 406 is closed. In at least one embodiment, the permanent door 406 defines a curved or arcuate corner 516 that is rounded in order to pivot across the jamb gasket projection 514 without interfering with the corresponding gasket or seal.

Referring now to FIG. 5B, the permanent transom 404 is depicted as being permanently attached to the frame-side transom 110. The permanent transom 404 may be the same or similar to the temporary transom 204 (FIG. 3B) and, therefore, may be best understood with reference thereto, where like numerals will correspond to like components not described again in detail. As illustrated, the frame-side transom 110 provides the base 328 and the opposing first and second legs 330a, b extending from the base 328, and the permanent transom 404 similarly provides the base 332 and the opposing first and second legs 334a, b extending from the base 332. The frame-side and permanent transoms 110, 404 provide the complementary mating features 342a, b, as generally described above. In particular, the first mating feature 342 a includes the notch 344 provided on each leg 330a, b of the frame-side transom 110, and the second mating feature 342b includes the protrusion 346 provided on each leg 334a, b of the temporary transom 204.

The internal closer may be installed in the interior 340 of the frame-side transom 110, between the opposing second legs 334a and 334b of the permanent transom 404. The internal closer may facilitate automatic closing of the corresponding door 406. More specifically, the internal closer may cause the door 406 to pivot into a closed position abutting a door stop 518 provided by or otherwise attached to the permanent transom 404. The door stop 518 may extend along the entire length of the permanent transom 404.

The permanent transom 404 may include features for receiving and securing the internal closer within the frame side and permanent transom 110, 404. For example, the base 332 of the permanent transom 404 may be partially open along a length of the permanent transom 404 such that the internal closer can be installed through the base 332 of the permanent transom 404. The permanent transom 404 may include a cover plate (obscured from view) to fill the opening in the base 332, thereby allowing the internal closer to be secured within the interior 340. One or more screws 520 may be used to secure the cover plate to the hanger bracket 356.

Referring now to FIG. 5C, illustrated is another view of the permanent transom 404 attached to the frame-side transom 110, and away from the internal closer. The attachment between the permanent transom 404 and the frame-side transom 110 is the same as disclosed in FIG. 5B, and therefore will not be described again. In FIG. 5C, an end of the hanger bracket 356 is visible, and the hanger bracket 356 is the support for the opposite side of the closer mounted inside the transom.

In at least one embodiment, the frame-side transom 110 is non-thermally insulating. In other embodiments, however, the frame-side transom 110 is thermally insulating, and in such embodiments, the frame-side transom 110 may include one or more thermal breaks 522 configured to thermally separate exterior and interior portions of the header. In one or more embodiments, the thermal break 522 may comprise, for example a pour-and-debridge thermal break, but other thermal break techniques and technologies can similarly be utilized.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, interior, exterior and the like are used in relation to the illustrative embodiments as they are depicted in the figures, the upward direction being toward the top of the corresponding figure and the downward direction being toward the bottom of the corresponding figure.

The invention claimed is:

1. An enclosure system for a building, comprising:
an entryway for the building defined by opposing left and right frame-side jambs and a frame-side transom extending between the left and right frame-side jambs;
a temporary enclosure system installable within the entryway and including:
a left temporary door-side jamb attachable to the left frame-side jamb to form a temporary assembled left jamb;
a right temporary door-side jamb attachable to the right frame-side jamb to form a temporary assembled right jamb;
a temporary transom attachable to the frame-side transom to form a temporary assembled transom; and
one or more temporary doors extending between the temporary assembled left and right jambs and vertically to the temporary assembled transom; and
after removing the temporary enclosure system from the entryway, a permanent enclosure system installable within the entryway and including:
a left permanent door-side jamb attachable to the left frame-side jamb to form a permanent assembled left jamb;
a permanent right door-side jamb attachable to the right frame-side jamb to form a permanent assembled right jamb;
a permanent transom attachable to the frame-side transom to form a permanent assembled transom; and
one or more permanent doors hung within the entryway and extending between the permanent assembled left and right jambs and vertically to the permanent assembled transom.

2. The enclosure system of claim 1, wherein the left and right frame-side jambs each include a first mating feature, and the left and right temporary door-side jambs each include a second mating feature matable with the first mating feature to operatively couple the left and right temporary door-side jambs to the left and right frame-side jambs, respectively.

3. The enclosure system of claim 2, wherein the first mating feature comprises a channel, and the second mating feature comprises a flange sized to be received within the channel.

4. The enclosure system of claim 1, wherein the frame-side transom includes a first base and opposing first and second legs extending from the first base, and the temporary transom includes a second base and opposing third and fourth legs extending from the second base, and wherein the third and fourth legs are received within an interior region defined between the opposing first and second legs.

5. The enclosure system of claim 4, wherein the first and second legs each provide a first mating feature, and the third and fourth legs each provide a second mating feature matable with the first mating feature as the third and fourth legs are received within the interior region.

6. The enclosure system of claim 1, wherein the temporary enclosure system further includes one or more cover plates attachable to opposing sides of the temporary assembled transom.

7. The enclosure system of claim 1, wherein the left and right frame-side jambs each include a first mating feature, and the left and right permanent door-side jambs each include a second mating feature matable with the first mating feature to operatively couple the left and right permanent door-side jambs to the left and right frame-side jambs, respectively.

8. The enclosure system of claim 7, wherein the first mating feature comprises a channel, and the second mating feature comprises a flange sized to be received within the channel.

9. The enclosure system of claim 7, wherein one or more notches are defined on the first mating feature and a corresponding one or more protrusions are defined on the second mating feature and sized to be received by the one or more notches.

10. The enclosure system of claim 1, wherein the frame-side transom includes a first base and opposing first and second legs extending from the first base, and the permanent transom includes a second base and opposing third and fourth legs extending from the second base, and wherein the third and fourth legs are received within an interior region defined between the opposing first and second legs.

11. The enclosure system of claim 10, wherein the first and second legs each provide a first mating feature, and the third and fourth legs each provide a second mating feature matable with the first mating feature as the third and fourth legs are received within the interior region.

12. The enclosure system of claim 10, wherein the permanent enclosure system further includes an internal closer arranged within the permanent assembled transom.

13. The enclosure system of claim 1, further comprising one or more wires positioned within a cavity defined by at least one of the left frame-side jamb, the right frame-side jamb, or the frame-side transom.

14. A method of constructing an enclosure system for a building, comprising:
constructing an entryway for the building, the entryway being defined by opposing left and right frame-side jambs and a frame-side transom extending between the left and right frame-side jambs;
installing a temporary enclosure system within the entryway and thereby securing the building, wherein installing the temporary enclosure system includes:
attaching a left temporary door-side jamb to the left frame-side jamb and thereby forming a temporary assembled left jamb;
attaching a right temporary door-side jamb to the right frame-side jamb and thereby forming a temporary assembled right jamb;
attaching a temporary transom to the frame-side transom and thereby forming a temporary assembled transom; and
hanging one or more temporary doors within the entryway, the one or more temporary doors extending between the temporary assembled left and right jambs and vertically to the temporary assembled transom;
removing the temporary enclosure system from the entryway;
installing a permanent enclosure system within the entryway and thereby securing the building, wherein installing the permanent enclosure system includes:
attaching a left permanent door-side jamb to the left frame-side jamb and thereby forming a permanent assembled left jamb;
attaching a right permanent door-side jamb to the right frame-side jamb and thereby forming a permanent assembled right jamb;
attaching a permanent transom to the frame-side transom and thereby forming a permanent assembled transom; and
hanging one or more permanent doors within the entryway, the one or more permanent doors extending between the permanent assembled left and right jambs and vertically to the permanent assembled transom.

15. The method of claim 14, wherein the left and right frame-side jambs each include a first mating feature, and the left and right temporary door-side jambs each include a second mating feature, and wherein the attaching the left and right temporary door-side jambs to the left and right frame-side jambs, respectively, comprises mating the first and second mating features and thereby operatively coupling the left and right temporary door-side jambs to the left and right frame-side jambs, respectively.

16. The method of claim 14, wherein the frame-side transom includes a first base and opposing first and second legs extending from the first base, and the temporary transom includes a second base and opposing third and fourth legs extending from the second base, and wherein attaching the temporary transom to the frame-side transom comprises receiving the third and fourth legs within an interior region defined between the opposing first and second legs.

17. The method of claim 14, wherein the left and right frame-side jambs each include a first mating feature, and the left and right permanent door-side jambs each include a second mating feature, and wherein attaching the left and right permanent door-side jambs to the left and right frame-side jambs, respectively, comprises mating the first and second mating features and thereby operatively coupling the left and right permanent door-side jambs to the left and right frame-side jambs, respectively.

18. The method of claim 14, wherein the frame-side transom includes a first base and opposing first and second legs extending from the first base, and the permanent transom includes a second base and opposing third and fourth legs extending from the second base, and wherein attaching the permanent transom to the frame-side transom comprises receiving the third and fourth legs within an interior region defined between the opposing first and second legs.

19. The method of claim 14, further comprising installing an internal closer within the permanent assembled transom.

20. The method of claim 14, wherein installing the permanent enclosure system further includes attaching one or more cover plates to opposing sides of the permanent assembled transom.

21. The method of claim 14, further comprising positioning one or more wires within a cavity defined by at least one of the left frame-side jamb, the right frame-side jamb, or the frame-side transom.
